(19) United States
(12) Patent Application Publication
(10) Pub. No.: US 2008/0295451 A1
(43) Pub. Date: Dec. 4, 2008

(54) Blank for Spacer for Insulating Window Unit, Spacer for Insulating Window Unit, Insulating Window Unit and Method For Manufacturing a Spacer

(76) Inventors: Erwin Brunnhofer, Fuldabruck (DE); Karl-Hans Caprano, Kassel (DE)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/573,166

(22) PCT Filed: Aug. 2, 2005
(86) PCT No.: PCT/EP2005/008362

§ 371 Date: Feb. 2, 2007

Related U.S. Application Data
(60) Provisional application No. 60/598,704, filed on Aug. 4, 2004.

(51) Int. Cl. E06B 3/663; B32B 5/00; B32B 7/12; E06B 3/673; B32B 1/08; B21D 21/00

(52) U.S. Cl. 52/786.13; 428/220; 428/335; 428/76; 428/36.91; 72/40; 72/379.2

(57) ABSTRACT

A blank for a spacer for an insulating window unit preferably includes a core made of a metal sheet, e.g., stainless steel, and a coating made of a synthetic material, e.g., polypropylene. The coating preferably has a thickness in the range of 0.02 to 0.2 mm and the core preferably has a thickness in the range of 0.05 to 2 mm, more preferably between 0.1 to 0.3 mm. Further, the insulating window unit preferably includes at least two glass windows, which extend in parallel and are spaced a first distance from each other. The first distance preferably is maintained by the above-mentioned spacer, which spacer is adhered to the glass windows using an adhesive or a sealing compound.

### CROSS-REFERENCE TO RELATED APPLICATIONS

This application claims priority to U.S. provisional application no. 60/598,704, filed 4 Aug. 2004, the contents of which are incorporated herein.

### TECHNICAL FIELD

The present invention relates to a blank for a spacer for an insulating window unit, a spacer for an insulating window unit, an insulating window unit and a method for manufacturing a spacer.

### BACKGROUND OF THE INVENTION

A variety of spacers for insulating window units are known, for example, from U.S. Pat. No. 5,313,761, U.S. Pat. No. 5,675,944, U.S. Pat. No. 6,038,825, U.S. Pat. No. 6,068,720 and U.S. Pat. No. 6,339,909. For example, one type of spacer is a spacer made of a metal sheet, which is U-shaped in cross-section (see FIG. 6, 7 of U.S. Pat. No. 6,068,720 or FIG. 10 of U.S. Pat. No. 5,675,944) or which is bent into a shape that opens to one side in cross-section.

Also known are shapes, which are closed in cross-section, made of co-extruded profiles made of metal and synthetic material (see U.S. Pat. No. 6,339,909, e.g., FIG. 2, which patent also shows in FIG. 11 a profile that is open on one side in cross-section).

### SUMMARY OF THE INVENTION

It is an object of the invention to provide options for improving a spacer for an insulating window unit, which spacer is produced by bending a metal sheet.

This object is solved by coating the blank (the metal sheet) with a synthetic material, preferably a polypropylene.

The blank is then bent, after further preparatory working if necessary, into a spacer.

The use of the synthetic material (preferably polypropylene) coated sheet metal as a blank offers diverse advantages for the manufactured spacer, or in relation to the insulating window unit manufactured with the manufactured spacer. On the one hand, the use of the metal sheet provides, similar to the uncoated metal sheet, a good diffusion barrier that prevents, in combination with additional sealings, the gas filled between the two glass panes of the insulating window unit from being contaminated or leaking out by diffusion. The coating with the polypropylene enables an improved connection of the space with an adhesive and/or a sealing material of the additional sealings, which is/are used in the edge area of the insulating window unit, and in certain cases rust protection. Moreover, the use of the blank, which is preferably cold (i.e. at room temperature) bendable, enables the raw material to be supplied as a rolled material for the production of the insulating window unit and to be bent on-site into the shape of the spacer. When the known spacer with the composite metal-synthetic material structure is used, the spacer must be produced as a rod material (usually 6 m in length), which leads to substantial loss through waste when the rod material is cut to the necessary length during the production of the insulating window unit. By using the rolled material in combination with the cross-section produced by bending, a spacer with a composite metal-synthetic material structure can be provided without the necessity of using the rod material, and the consequently resulting cut waste. The reason is that the spacer made of rolled material can be bent into the necessary shape in a relatively simple way during the production of the insulating window unit.

In the selection of the synthetic material, preferably polypropylene, polyethylene terephtalate, polyamide or polycarbonate, which can contain the usual fillers, additives, dyes, UV-protection agents, etc., attention should be paid that no noticeable escape of gases and/or moisture from the synthetic material (fogging) results, that a good connection is provided with the adhesive (e.g., butyl-adhesive) that will be used during the production of the insulating glass unit, and that a good connection to the metal sheet can be provided. The thermal conductivity λ of the synthetic material should be less than 0.3 W/mK.

Preferred materials for the synthetic material are, e.g., polypropylene Novolen 1040K or MCU 208U (obtainable from Borealis A/S, Denmark) or BA110CF (obtainable from Borealis A/S, Denmark) or ADSTIF HA 840K (obtainable from Basell Polyolefins Company N.V.).

Steel or stainless steel can be used as the sheet, if necessary, each being coated, e.g., with tin or zinc. Such a coating with tin or zinc can have a thickness in the range, e.g., of 0.2 to 0.5 μm. For example, such a sheet is tin plate, which is a steel- or iron sheet having a surface coating of tin, and suitable stainless steel varieties are, e.g., 4301 or 4310 according to the German steel classification. The thermal conductivity λ of the sheet should be less than 50 W/mK.

To produce a good adhesion between the metal sheet and the synthetic material coating, preferably polypropylene, an adhesive agent can be used, such as e.g., an adhesive agent based on maleic anhydride, such as e.g., Admer™ from Mitsui Chemical Europe. This adhesive agent can be either applied to the metal sheet as a separate layer, e.g. with a thickness of 50 μm (preferably 20-100 μm), or the adhesive agent can be mixed in the synthetic material.

The blank, its materials and their connection are selected such that the connection of the metal sheet and the synthetic material is maintained even during plastic deformation at room temperature (cold bending) with a bent edge curvature radius R1 in the range of 0.2 to 2 mm, preferably about 1 mm (0.039 inches), and no cracks occur in the synthetic material coating.

### BRIEF DESCRIPTION OF THE DRAWINGS

Examples for a blank and a spacer bent from the blank will be explained in more detail with reference to the figures.

FIG. 1 shows in view (a) (below left) a cross-section of a coated blank and in view (b) (above left) a cross-section of a spacer bent from the blank of a first embodiment.

FIG. 2 shows in view (a) (below left) a cross-section of a coated blank and in view (b) (above left) a cross-section of a spacer bent from the blank of a second embodiment.

FIG. 3 shows an insulating window unit, in which a spacer according to the present teachings maintains the separation of two window panes.

### DETAILED DESCRIPTION OF THE PREFERRED EMBODIMENT

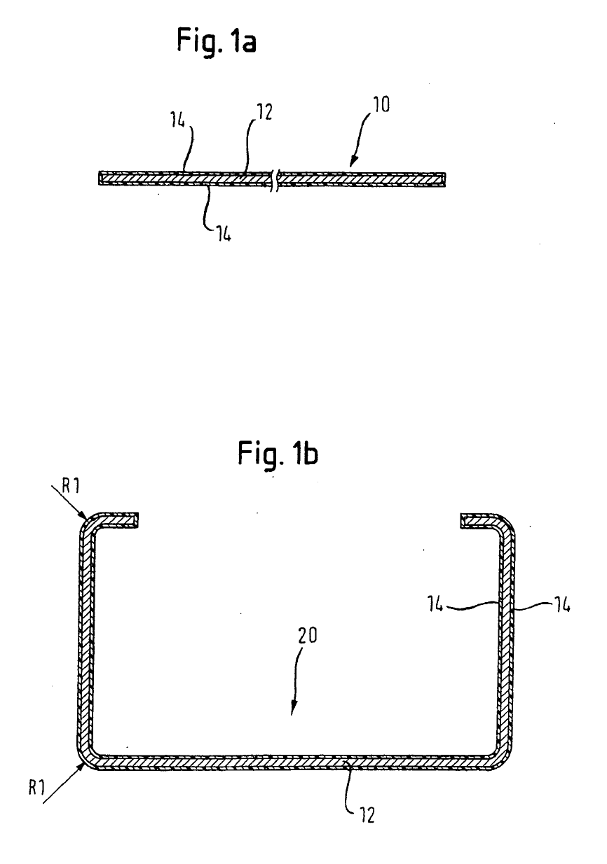

As can be easily recognized in FIG. 1(a), the blank 10 of the first embodiment has a “core” 12 made of a metal sheet (steel), which metal sheet has a predetermined width (in the example about 37.3 mm) and a predetermined thickness (in the example about 0.3 mm) and which metal sheet is completely surrounded by (coated with) a polypropylene layer 14 having a predetermined thickness (in the example about 0.1 mm).

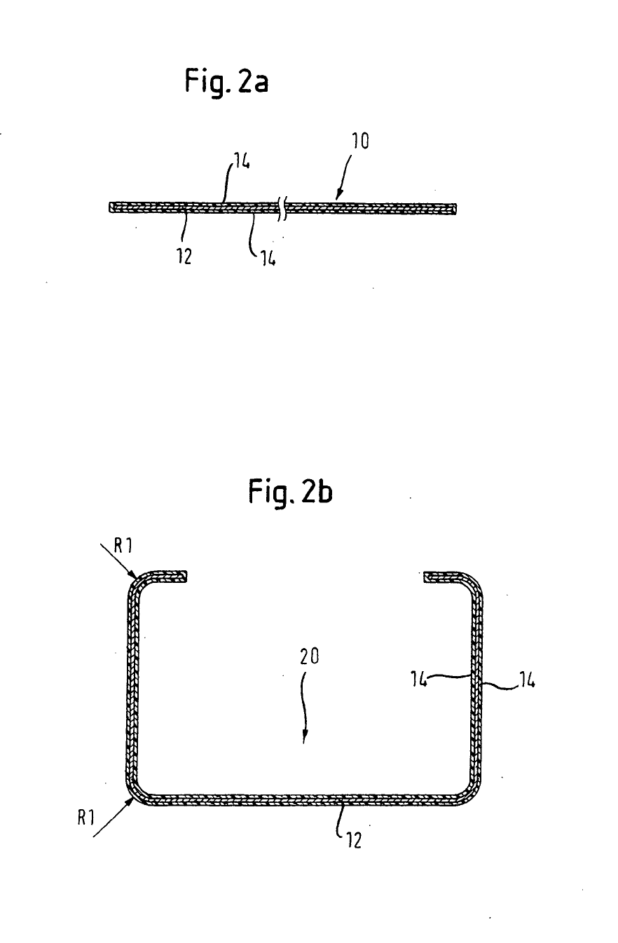

As can be easily recognized in FIG. 2(a), the blank 10 of the second embodiment has a “core” 12 made of a metal sheet (steel), which metal sheet has a predetermined width (in the example about 32.9 mm) and a predetermined thickness (in the example about 0.1 mm) and which metal sheet is completely surrounded by (coated with) a polypropylene layer 14 having a predetermined thickness (in the example about 0.1 mm).

The blank 10 extends in the length direction perpendicular to the paper plane of the Figure and comprises, if necessary at suitable locations along its length direction, cut-outs, holes or other features that are necessary for the production of the spacer. The core 12 preferably has a thickness in the range of 0.05 to 2 mm, more preferably between 0.1 to 0.3 mm.

The preferred cross-sectional shape of a spacer 20 manufactured from the blank 10, which spacer 20 is perpendicular in its length direction to the paper plane in FIGS. 1 and 2, is shown in view (b) of each of FIGS. 1 and 2. The cross-section shape corresponds to a hollow (empty) rectangular with rounded-off corners having curvature radius R1, which rectangular is “cut-open” so that the interior of the hollow rectangular is open to one side. The cutout is defined by planar segments on this side of the rectangular, which segments are joined to the rounded-off corners, and which segments project in the plane of the side of the rectangle having the cut-out in the direction towards the direction of the cut-out by an amount in addition to the curvature of the corners, which amount corresponds to about a curvature radius R1. In case of using e.g., a granular drying material 36 (having a granular diameter, e.g., in the range of 0.2 to 3 mm, e.g., 1 mm), the distance of the planar segments defining the cut-out is less than the diameter of the granules of the drying material 36, because the drying material 36 could otherwise leak out of the spacer in the interior of the manufactured insulating glass unit, which means the distance of the free ends in FIG. 1b and 2b is less than the diameter of the granules, thus e.g. less than 1 mm.

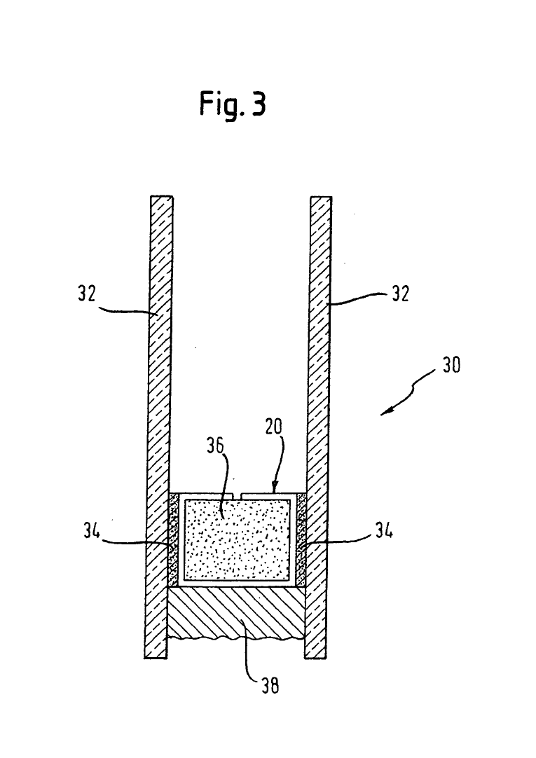

A spacer 20 is thus given, which is provided by bending (preferably cold bending) a blank 10 into an essentially hollow, rectangular shape in cross-section, which rectangular shape is open on one side, e.g., U-shaped or with a cut-out in a side of the rectangular, which blank 10 made of a metal sheet 12, preferably a steel sheet, and more preferably a sheet made of stainless steel, is formed with an attached coating 14 of synthetic material, preferably polypropylene. The layer strength of the synthetic material is selected so that the coating is not damaged during bending (cold bending), preferably in the range of a layer thickness of 0.02 to 0.2 mm, and more preferably of 0.9 to 1.1 mm. As shown in FIG. 3, an insulating glass unit 30 can be manufactured with this spacer 20, which consists of either individual segments of such a spacer (for example, one segment per edge) or a spacer bent into a single-piece spacer frame (which if necessary is closed with a connector to become a closed frame), which spacer fixes the distance of the windows 32 of the insulating glass unit using an adhesive and/or a sealing compound 34 and simultaneously prevents the contamination or the escape of the gases disposed between the windows by diffusion.

Methods for making a spacer 20 according to the present teachings preferably include bending (preferably cold bending, e.g., between 0-40° C., more preferably between 10-30° C.) a blank 10 into an essentially hollow, rectangular shape in cross-section, which rectangular shape is open on one side, e.g., U-shaped or with a cut-out in a side of the rectangular. The blank 10 is preferably constructed according to one of the examples noted above and/or one of the claims noted below. Optionally, a drying or desiccating material 36 may be introduced into the bent spacer 20.

Methods for manufacturing an insulating window unit 30 may include disposing a spacer 20, e.g., preferably manufactured according to one of the examples noted above, between two window panes 32, so as to fix or set the separation distance of the windows 32 of the insulating glass unit 30. Either before, after or at the same time, an adhesive and/or a sealing compound 34 is disposed between the respective sides of the spacer 20 and the respective window panes 32 in order to adhere the spacer 20 to the respective window panes 32. A further adhesive or sealing compound 36 may be introduced thereafter into the outwardly facing space between the window panes 32 in order to further seal the inner space, which preferably contains an inert, insulating gas such as argon.

Each of the various features and teachings disclosed above may be utilized separately or in conjunction with other features and teachings to provide improved blacks for spacers, spacers and insulating window units and methods for designing, manufacturing and using the same. Representative examples of the present invention, which examples utilize many of these additional features and teachings both separately and in combination, were described above in detail with reference to the attached drawings. This detailed description is merely intended to teach a person of skill in the art further details for practicing preferred aspects of the present teachings and is not intended to limit the scope of the invention. Therefore, combinations of features and steps disclosed in the detailed description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

The contents of U.S. Pat. Nos. 5,313,761, 5,675,944, 6,038,825, 6,068,720 and 6,339,909, US Patent Publication No. 2005-0100691 and U.S. patent application Ser. No. 11/038,765 provide additional useful teachings that may be combined with the present teachings to achieve additional embodiments of the present teachings, and these patent publications are hereby incorporated by reference as if fully set forth herein.

1-14. (canceled)

15. A blank for a spacer for an insulating window unit comprising:
a core made of a metal sheet and having a thickness in the range of about 0.05 to 2 mm, and
a coating layer attached to the core, the coating layer comprising a synthetic material selected from the group consisting of polypropylene, polyethylene terephtalate, polyamide and polycarbonate and having a thickness in the range of about 0.02 mm to 0.2 mm, the coating layer possessing a property that no noticeable escape of gases and/or moisture from the coating layer results,
wherein the blank has the property of being storable in a rolled state without permanent deformation thereof.

16. A blank according to claim 15, wherein the core is made of a steel sheet.

17. A blank according to claim 15, wherein the core is made of a stainless steel sheet.

18. A blank according to claim 17, wherein an adhesive agent is disposed between the core and the coating and/or is a component of the synthetic material of the coating layer.

19. A blank according to claim 18, wherein the coating layer completely encloses the core.

20. A blank according to claim 19, wherein the blank possesses a property of being permanently bendable at temperature between 0-40° C. into a bent edge radius of curvature of between about 0.2 to 2 mm without cracks occurring in the coating layer.

21. A blank according to claim 20, wherein the core has a thermal conductivity less than 50 W/mK, the coating layer has a thermal conductivity less than 0.3 W/mK and the core has a thickness between 0.1 to 0.3 mm.

22. A blank according to claim 21, wherein the coating layer comprises polypropylene.

23. A blank according to claim 22, wherein the metal sheet of the core has a tin or zinc coating in a thickness range of about 0.2 to 0.5 μm.

24. A blank according to claim 15, wherein the core has a thermal conductivity less than 50 W/mK, the coating layer has a thermal conductivity less than 0.3 W/mK and the core has a thickness between 0.1 to 0.3 mm.

25. A blank according to claim 15, wherein the coating layer comprises polypropylene.

26. A blank according to claim 15, wherein an adhesive agent is disposed between the core and the coating and/or is a component of the synthetic material of the coating layer.

27. A blank according to claim 15, wherein the coating completely encloses the core.

28. A blank according to claim 15, wherein the metal sheet of the core has a tin or zinc coating in a thickness range of about 0.2 to 0.5 μm.

29. A blank according to claim 15, wherein the blank possesses a property of being permanently bendable at temperature between 0-40° C. into a bent edge radius of curvature of between about 0.2 to 2 mm without cracks occurring in the coating layer.

30. A spacer for an insulating window unit comprising the blank of claim 15, which has been bent along its length direction so as to have a cross-section of a hollow rectangle with an opening on one side, wherein corners of the hollow rectangular cross-section have a radius of curvature in the range of about 0.2 to 2 mm.

31. A spacer according to claim 30, further comprising granules of a desiccating material disposed within the hollow rectangular cross-section, the granules having a diameter larger than the opening in the one side of the spacer.

32. A spacer for an insulating window unit comprising the blank of claim 22, which has been bent along its length direction so as to have a cross-section of a hollow rectangle with an opening on one side, wherein corners of the hollow rectangular cross-section have a radius of curvature in the range of about 0.2 to 2 mm.

33. A spacer according to claim 32, further comprising granules of a desiccating material disposed within the hollow rectangular cross-section, the granules having a diameter larger than the opening in the one side of the spacer.

34. A spacer for an insulating window unit comprising the blank of claim 27, which has been bent along its length direction so as to have a cross-section of a hollow rectangle with an opening on one side, wherein corners of the hollow rectangular cross-section have a radius of curvature in the range of about 0.2 to 2 mm.

35. A spacer according to claim 34, further comprising granules of a desiccating material disposed within the hollow rectangular cross-section, the granules having a diameter larger than the opening in the one side of the spacer.

36. An insulating window unit comprising:
at least two windows extending substantially in parallel,
a spacer according to claim 31 disposed between the at least two windows so as to maintain a spacing between the at least two windows, and
an adhesive or sealing compound adhering the spacer to the at least two glass windows.

37. An insulating window unit according to claim 36, wherein the spacer is bent in the form of a one-piece spacer frame and essentially completely encloses an interior space defined by the one-piece spacer frame and the at least two windows.

38. An insulating window unit comprising:
at least two windows extending substantially in parallel,
a spacer according to claim 33 disposed between the at least two windows so as to maintain a spacing between the at least two windows, and
an adhesive or sealing compound adhering the spacer to the at least two glass windows.

39. An insulating window unit according to claim 38, wherein the spacer is bent in the form of a one-piece spacer frame and essentially completely encloses an interior space defined by the one-piece spacer frame and the at least two windows.

40. An insulating window unit comprising:
at least two windows extending substantially in parallel,
a spacer according to claim 35 disposed between the at least two windows so as to maintain a spacing between the at least two windows, and
an adhesive or sealing compound adhering the spacer to the at least two glass windows.

41. An insulating window unit according to claim 40, wherein the spacer is bent in the form of a one-piece spacer frame and essentially completely encloses an interior space defined by the one-piece spacer frame and the at least two windows.

42. A method for making a spacer for an insulating window unit, comprising:
bending a blank according to claim 15 into a configuration, in which a hollow interior is substantially or completely enclosed by the blank, wherein the bending is performed while the blank is at a temperature between about 0-40° C.

43. A method according to claim 42, further comprising:
further bending the spacer into the form of a one-piece spacer frame and
connecting terminal ends of the spacer to form a closed frame.

44. A method according to claim 43, further comprising at least partially filling the hollow interior with a desiccating material before the terminal ends of the spacer are connected.

45. A method for making a spacer for an insulating window unit, comprising:
bending a blank according to claim 22 into a configuration, in which a hollow interior is substantially or completely enclosed by the blank, wherein the bending is performed while the blank is at a temperature between about 0-40° C.

46. A method according to claim 45, further comprising:
further bending the spacer into the form of a one-piece spacer frame and
connecting terminal ends of the spacer to form a closed frame.

47. A method according to claim 46, further comprising at least partially filling the hollow interior with a desiccating material before the terminal ends of the spacer are connected.

48. A blank for a spacer for an insulating window unit comprising:
a core made of a steel sheet and having a thickness of 0.05 to 2 mm, and
a coating layer completely surrounding the core, the coating layer comprising polypropylene, having a thickness of 0.02 mm to 0.2 mm and having a property that no noticeable escape of gases and/or moisture from the coating layer results,
wherein the blank possesses a property of being storable in a rolled state without permanent deformation thereof and a property of being permanently bendable at temperature between 0-40° C. into a bent edge radius of curvature of between 0.2 to 2 mm without cracks occurring in the coating layer.

49. A blank according to claim 48, wherein the core has a thermal conductivity less than 50 W/mK and the coating layer has a thermal conductivity less than 0.3 W/mK.

50. A spacer for an insulating window unit comprising the blank of claim 49, which has been bent along its length direction so as to have a cross-section of a hollow rectangle with an opening on one side, wherein corners of the hollow rectangular cross-section have a radius of curvature of 0.2 to 2 mm.

51. An insulating window unit comprising:
at least two windows extending substantially in parallel,
a spacer according to claim 50 disposed between the at least two windows so as to maintain a spacing between the at least two windows, and
an adhesive or sealing compound adhering the spacer to the at least two glass windows.

52. An insulating window unit according to claim 51, wherein the spacer is bent in the form of a one-piece spacer frame and essentially completely encloses an interior space defined by the one-piece spacer frame and the at least two windows.
